(19) United States
(12) Patent Application Publication
(10) Pub. No.: US 2004/0225747 A1
(43) Pub. Date: Nov. 11, 2004

(54) Providing compiled bytecode applications to a wireless device

(76) Inventor: Zafer Kadi, Tempe, AZ (US)

Correspondence Address: Timothy N. Trop, TROP, PRUNER & HU, P.C., STE 100, 8554 KATY FWY, HOUSTON, TX, 77024-1841, US

(21) Appl. No.: 10/434,938

(22) Filed: May 9, 2003

(51) Int. Cl. G06F 15/16; G06F 9/45

(52) U.S. Cl. 709/232; 717/148

(57) ABSTRACT

In accordance with one embodiment of the present invention, a method includes communicating with a first data processing system if bytecodes exist in an application requested by a wireless device; and providing a compiled native code segment corresponding to at least a portion of the application to the wireless device from a remote source.

### BACKGROUND

Certain modern programming languages such as the JAVA™ language execute in a managed runtime environment (MRTE). MRTEs dynamically load and execute code that is delivered in a portable format. This code includes bytecodes which are machine independent and at a higher abstraction level than native instructions, and thus must be converted into native instructions via interpretation or compilation.

Present solutions for bytecode execution are either done with a virtual machine (VM), hardware acceleration or just-in-time (JIT) compilers. All of these solutions suffer at least several drawbacks, including slower speed than native code; additional memory requirements for a client device (such as a cellular phone, personal digital assistant (PDA), or notebook personal computer); and complications from interaction with different standards and different flavors of bytecode execution.

Many cellular phones and PDA's do not have the ability and resources to support large and cumbersome application systems such as VM's or JIT compilers, thus restricting the ability to extend services based on bytecode applications.

Present approaches taken in handheld wireless devices generate simplistic and device specific solutions, which limit the ability to distribute applications or other content. A need thus exist for a wireless device to obtain bytecode applications in native code without requiring an on-board JIT compiler or the like.

### BRIEF DESCRIPTION OF THE DRAWINGS

FIG. 1 is a block diagram of a system in accordance with one embodiment of the present invention.

FIG. 2 is a block diagram of a wireless network in accordance with one embodiment of the present invention.

FIG. 3 is a flow diagram of a method in accordance with one embodiment of the present invention.

FIG. 4 is a flow diagram of a method in accordance with another embodiment of the present invention.

FIG. 5 is a block diagram of a wireless device with which embodiments of the present invention may be used.

### DETAILED DESCRIPTION

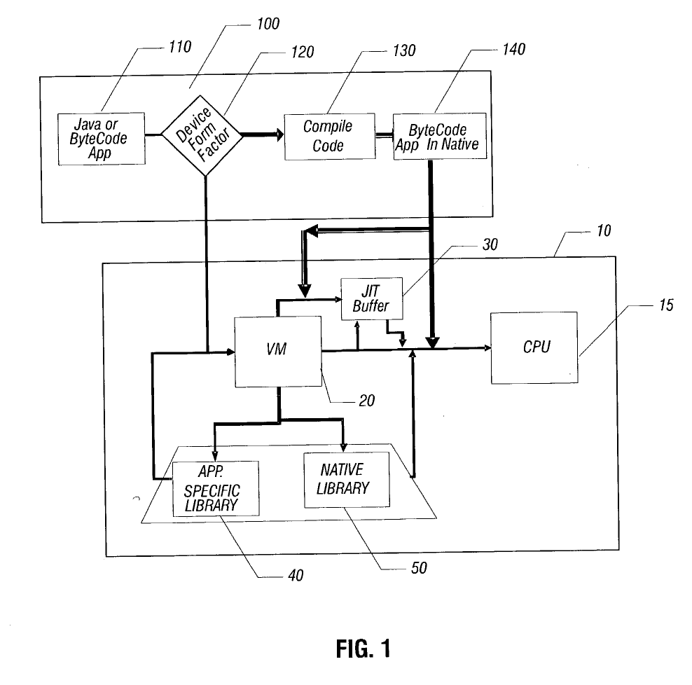

Referring to FIG. 1, shown is a block diagram of a system in accordance with one embodiment of the present invention. As shown in FIG. 1, the system includes a mobile station 10 which in one embodiment may be a cellular telephone, PDA or other wireless device. As shown in FIG. 1, mobile station 10 may include a central processing unit (CPU) 15 which executes instructions. Mobile station 10 may also include a virtual machine 20, which may be used to translate instructions of a JAVA™-based application or other bytecode application. As shown in FIG. 1, an application specific library 40 and a native library 50 may be coupled to the virtual machine 20. Also, a JIT buffer 30 may be coupled to virtual machine 20. Such a JIT buffer may be used to store native code instructions translated via virtual machine 20 for execution by CPU 15. In various alternative embodiments of the present invention, virtual machine 20 and JIT buffer 30 may be optional, as compiled versions of bytecode applications may be provided directly to CPU 15, as discussed below.

Also shown in FIG. 1 is a server 100 which in one embodiment may be a server residing at operator's location on a wireless network. In such an embodiment, server 100 may be a trusted server hosted by a wireless service provider. However, in other embodiments server 100 may be located elsewhere. More so, while discussed in the embodiment of FIG. 1 as a server, it is to be understood that server 100 may be any suitable data processing system such as a personal computer, laptop computer or the like.

As shown in FIG. 1, server 100 may receive an application 110 which may be a JAVA™ application or other such application including bytecodes, although the scope of the present invention is not limited in this respect. Server 100 may also receive form factor information 120 regarding mobile station 10. In certain embodiments, such form factor information 120 may include information such as device type, processor type, whether and to what extent a JIT compiler or VM exists on the platform, and the like. While form factor information 120 may be communicated to server 100 directly from mobile station 10 (e.g., via an extensible markup language (XML) construct), in other embodiments form factor information 120 may be obtained via a visitor location register or home location register of a wireless network.

Based on this information, server 100 may compile (in block 130) application 110 into a native code application 140 which may be provided to mobile station 10, directly to CPU 15 in one embodiment. Such native code application 140 may also be stored in server 100 in certain embodiments. Alternately, a portion of a bytecode application 110 may be compiled in server 100 with the compiled native code portion provided directly to CPU 15 and remaining bytecodes provided to virtual machine 20 for translation and/or compilation on a JIT compiler of mobile station 10.

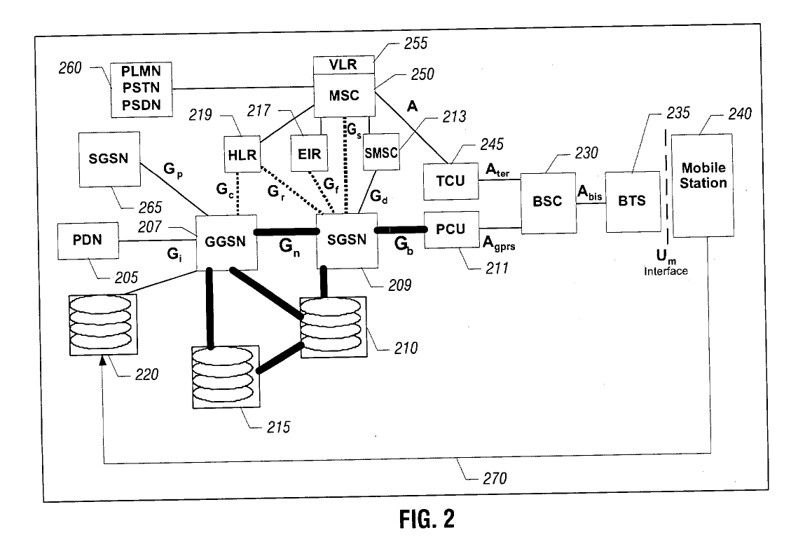

Referring now to FIG. 2, shown is a block diagram of a wireless network in accordance with one embodiment of the present invention. As shown in FIG. 2, the wireless network may support General Packet Radio Services (GPRS) or another data service. GPRS may be used by wireless devices such as cellular phones of a 2.5G (generation) or later configuration. GPRS may be provided on existing time division multiple access (TDMA) or Global System for Mobile Communication (GSM) networks, for example. Other embodiments of the present invention may be implemented in a circuit switched network such as used by 2G technologies, a Personal Communications System (PCS) network, a Universal Mobile Telecommunications System (UMTS) or UMTS Telecommunications Radio Access (UTRA) network or other network.

As shown in FIG. 2, the wireless network includes various sources connected through a core part of the network to outside fixed networks such as a Public Data Network 205 or other public network, for example, a Public Land Mobile Network (PLMN), Public Switched Telephone Network (PSTN) or Integrated Services Digital Network (ISDN) (collectively 260).

In the embodiment of FIG. 2, PDN 205 may be coupled to a gateway GPRS support node (GGSN) 207 via interface Gi. In one embodiment such an interface may use Internet Protocol (IP) or X.25 protocols. A serving GPRS support node (SGSN) 209 may be coupled to GGSN 207 via a Gₙ interface. In one embodiment, such an interface may use IP routing or GPRS Tunnel Protocol. SGSN 209 may be used to deliver data packets to and from mobile stations within its geographical service area, while GGSN 207 may act as a gateway between the wireless network and an IP network.

As further shown in FIG. 2, a packet control unit (PCU) 211 may be coupled to SGSN 209. PCU 211 may manage radio related aspects of GPRS communications. In one embodiment a G_{b} interface between SGSN 209 and PCU 211 may use frame relay protocols. In turn, PCU 211 may be coupled via A_{GPRS} to a base station controller (BSC) 230. In one embodiment BSC 230 may manage radio resources for a base transceiver station (BTS) 235 to which it is coupled via an A_{bis} interface. In one embodiment, BTS 235 may house radio transceivers that define a cell and handle radio link protocols with different mobile stations of the network. For example, mobile station 240 may communicate with BTS 235 via the Uₘ interface.

In one embodiment mobile station 240 may be identical to mobile station of FIG. 1, and may be a cellular phone, PDA or other wireless device. Further, mobile station 240 may include a subscriber identity module (SIM) which may be a smart card or other circuitry that provides personal mobility to a user. Mobile station 240 may also include a GSM transceiver for communication within the wireless network, as well as a wireless local area network (WLAN) interface to communicate with devices outside of the wireless network via a WLAN.

As shown further in FIG. 2, GGSN 207 may be coupled to a SGSN 265 via a Gₚ interface. Such SGSN may be for a different PLMN, for example. More so GGSN 207 may be optionally coupled (via a GC interface which may use an extension of mobile application part (MAP)) to a home location register (HLR) 219 which in turn is coupled to a mobile service switching center (MSC) 250 which may include a visitor location register 255. HLR 219 may include administrative information of each user in the network and the current location of the associated mobile station. As shown in FIG. 2, HLR 219 may optionally be coupled to SGSN 209 via a Gr interface. In one embodiment, MSC 250 may act like a normal switching node for the network and may also provide all functionality needed to handle a mobile user such as registration, authentication, location updating, handovers and the like.

As shown further in FIG. 2, MSC 250 may be coupled to an equipment identity register (EIR) 217 which may include a database containing a list of all valid mobile equipment on the network. Optionally, EIR 217 may be coupled to SGSN 209 via a G_{f} interface. Similarly MSC 250 may be coupled to a short message service center (SMSC) 213 which is used to route short messages to recipients.

As shown in FIG. 2, SMSC 213 may also be coupled to SGSN 209 via a G_{d} interface which may be used to deliver short message services (SMS) messages using MAP protocol. Optionally, MSC 250 may be coupled to SGSN 209 via a Gₛ interface. MSC 250 may also be coupled to fixed networks such as a PLMN, PSTN or ISDN 260. Also, MSC 250 may be coupled to a Trans Coding Unit (TCU), 245 which in turn may be coupled to BSC 230 via an Aₜₑᵣ interface. TCU 245 may enable speech compression and data rate adaptation within the wireless network.

As further shown in FIG. 2, a plurality of data processing systems may be coupled to the wireless network. Specifically, a first server 210 and a second server 215 may be coupled both to each other and to GGSN 207. In one embodiment these servers may be located at an operator's network and may be used to perform compilation of bytecode applications in accordance with various embodiments of the present invention. As further shown in FIG. 2, server 210 may be directly coupled to SGSN 209.

While discussed as servers, it is to be understood that servers 210 and 215 may be any suitable data processing system, as discussed above. In one embodiment, server 210 may be a trusted server hosted by a wireless service provider. Server 210 in such embodiments may include a number of previously compiled bytecode applications. In certain embodiments, these applications may have been compiled by an on-board ahead-of-time (AOT) and/or just-in-time (JIT) compiler. Such compiled applications may be stored in a database residing on server 210. Servers 210 and 215 may be any commercially available server in various embodiments, and may include conventional components and memory devices such as synchronous dynamic random access memory (SDRAM), static random access memory (SRAM), double data rate (DDR) memory and the like.

In various embodiments, server 210 may be coupled to server 215 to provide applications thereto for compiling. Also, server 210 (and/or server 215) may store such compiled applications in a database therein. In certain embodiments, such applications may be cached based on a caching algorithm. As will be discussed further below, such compiled applications may be provided to a mobile station 240 via servers 210 or 215 through the wireless network.

As further shown in FIG. 2, a third server 220 may be coupled directly to mobile station 240 via interface 270. While interface 270 may vary, in certain embodiments the interface may be a WLAN connection based on the Institute of Electrical and Electronic Engineers (IEEE) 802.11b standard, IEEE std. 802.11b-1999 (published Sep. 16, 1999) (also known as “WiFi”), IEEE std. 802.11a-1999 (published Sep. 16, 1999), IEEE std. 802.11g (published Sep. 21, 2000), or a similar connection using BLUETOOTH™ technology. In other embodiments, interface 270 may be a wired connection.

In one embodiment server 220 may be at a location outside of a wireless network provider's network. In certain embodiments server 220 may be a personal computer or a laptop computer of a user, for example, the user of mobile station 240. Alternately, as shown in FIG. 2, in other embodiments, server 220 may be coupled to GGSN 207 for connection to the network.

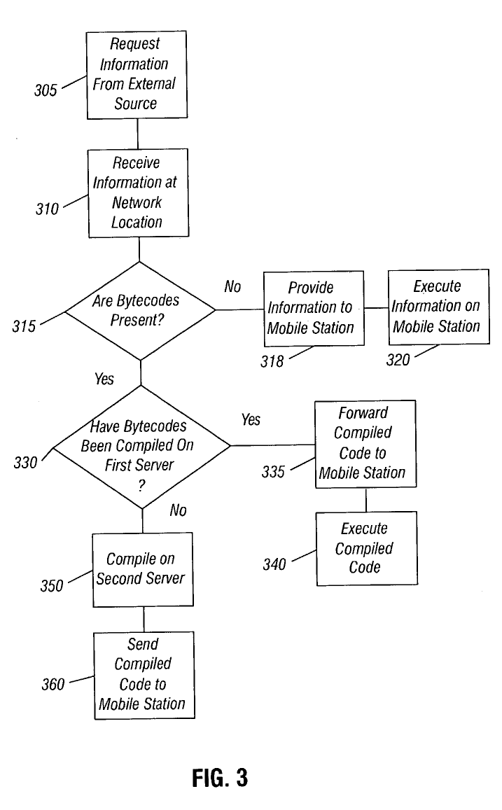

Referring now to FIG. 3, shown is a flow diagram of a method in accordance with one embodiment of the present invention. As shown in FIG. 3, the method may be initiated by a user of a mobile station. As shown in FIG. 3, the method may request information from an external source (block 305). In certain embodiments, the mobile station may request various types of information from a location either inside or outside of an operator's wireless network. For example a mobile station may request Internet-type browser information using a mini-browser capable of handling data-rich wireless application protocol (WAP) transmissions. Such information may be for example a webpage, an application such as a video game or another program. In various embodiments such information may be downloaded from a number of sources including a wireless network to which the mobile station is connected, a fixed network, or an external network such as the Internet.

As shown further in FIG. 3, the requested information is received at the mobile station (block 310). While in certain embodiments the information may proceed directly to the mobile station, in other embodiments the information may be preprocessed at another point along the wireless network. Next it is determined whether bytecodes are present in the information (diamond 315). For example, in various embodiments, a GGSN or SGSN may preprocess a data stream containing the information to determine whether bytecodes are present. If so, the GGSN or SGSN may request a native copy (e.g., a JIT compiled version) from the first server or other data processing system.

In addition, in certain embodiments the information requested may be checked for various protocol types at a server of a service provider, a SGSN, GGSN, or the like. In certain embodiments, the information may be checked using multipurpose internet mail extensions (MIME) types or other technologies to determine whether bytecodes exist inside the information. More so, in certain embodiments the information may be checked for security issues such as viruses and the like.

Referring again to FIG. 3, if no such bytecodes are present, the information may be provided to the mobile station (block 318) and the information may be executed on the mobile station (block 320).

As further shown in FIG. 3, if bytecodes are present in the information obtained, next it is determined whether the bytecodes have been compiled on a first server (diamond 330). For example as discussed above, the first server may be located at a network service provider location. However it is to be understood that such a first server may be any type of any data processing system and need not be located at the service provider. If the bytecodes have been compiled on the first server, the compiled code may be provided to the mobile station (block 335).

In certain embodiments, the compiled code may be sent to the mobile station in an optimized condition. Such optimization may be performed via prefetching or pushing and may be static or dynamic in certain embodiments. For example, such static optimization may be based on compiler data in which different code chunks are sent to the mobile station. Alternately, optimization may be performed dynamically based on collected data with each application's usage profile prefetch pages or other similar procedures. In certain embodiments, compiled applications may be provided in various formats such as MIME, XML or simple object access protocol (SOAP) format. Compiled applications may be sent in a compressed state, in certain embodiments.

Referring again to FIG. 3, the compiled code may then be executed by the mobile station (block 340). Alternately, if the bytecodes have not been compiled on the first server, in one embodiment the bytecode application may be provided to a second server for compilation (block 350). Such compiled code may then be sent to the mobile station (block 360). In certain embodiments, such compiled code may be cached on either the first or second server, based on a desired caching algorithm for example. Of course, the compiled code may then be executed by the mobile station.

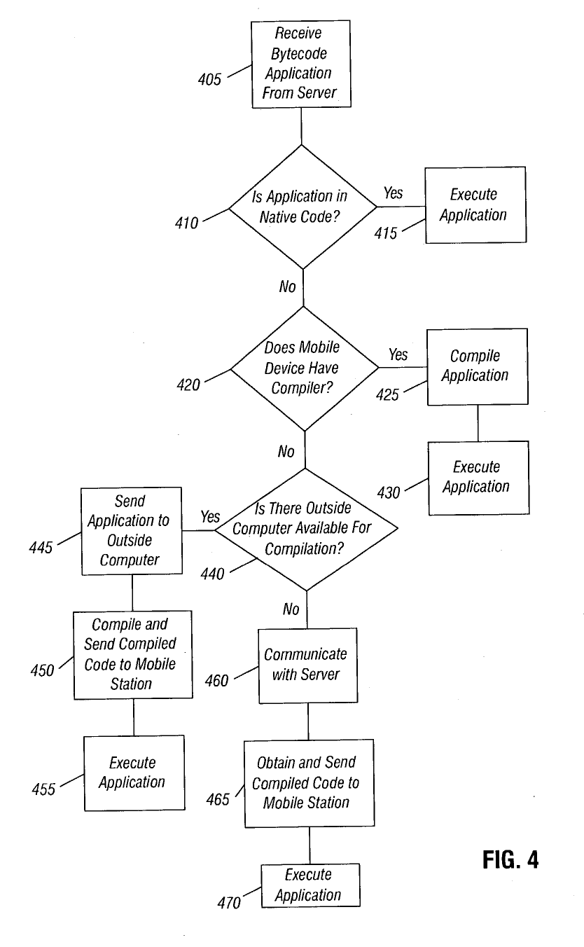

Referring now to FIG. 4, shown is a flow diagram of a method in accordance with another embodiment of the present invention. As shown in FIG. 4, this method may be initiated via a mobile station. In certain instances, an application received by a mobile station from a server may still contain bytecodes. For example, such a situation may occur when filters operating on a server do not properly filter an incoming application for the presence of bytecodes.

As shown in FIG. 4, the bytecode application is received from the server (block 405). Next it is determined whether the application is in native code (diamond 410). If so, the mobile station may directly execute the application (block 415). If not, in one embodiment the mobile station may determine whether it has a compiler on-board (diamond 420). For example, it may be determined whether a suitable JIT compiler exists on the mobile station. If so, the mobile station may compile the application (block 425) and execute the application (block 430).

As further shown in FIG. 4, if the mobile station does not have compiler, in one embodiment it may be determined whether there is an outside data processing system (e.g., a computer) available for compilation (diamond 440). As discussed above regarding FIG. 2, such an outside computer may be a personal computer or laptop computer with which a mobile station may communicate via a WLAN link, for example. If such a computer exists, the application may be sent to the outside computer (block 445). The outside computer may then compile and send the compiled code to the mobile station (block 450). The application may then be executed on the mobile station (block 455).

Alternately if no such outside computer exists, in one embodiment the mobile station may communicate back to a server, for example the first server (block 460). Such communication may request a properly compiled version of the bytecode application. The server may obtain and send a compiled code version back to the mobile station (block 465). For example, the server may have in its cache a compiled version of the application, or it may perform a compilation, or it may request such a compiled version from another server to which it is coupled. Finally upon receipt of compiled code, the mobile station may execute the application (block 470). Alternately, if such a compiled version is not available to the mobile station, it may transmit an error message to the server, in certain embodiments.

Embodiments may be implemented in a computer program. As such, these embodiments may be stored on a storage medium having stored thereon instructions which can be used to program a computer system to perform the embodiments. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs), erasable programmable read-only memories (EPROMs), electrically erasable programmable read-only memories (EEPROMs), flash memories, magnetic or optical cards, or any type of media suitable for storing electronic instructions. Similarly, embodiments may be implemented as software modules executed by a programmable control device, such as a computer processor or a custom designed state machine.

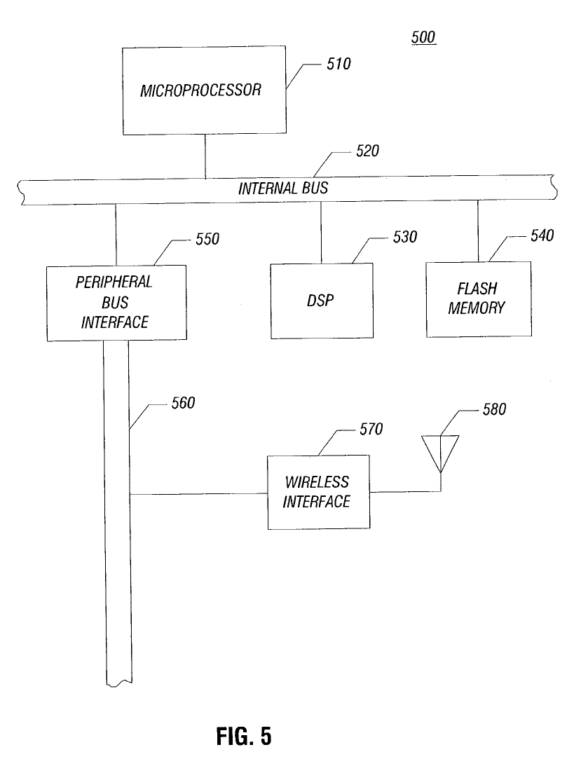

FIG. 5 is a block diagram of a wireless device with which embodiments of the invention may be used. As shown in FIG. 5, in one embodiment wireless device 500 includes a processor 510, which may include a general-purpose or special-purpose processor such as a microprocessor, microcontroller, application specific integrated circuit (ASIC), a programmable gate array (PGA), and the like. Processor 510 may be coupled to a digital signal processor (DSP) 530 via an internal bus 520. A flash memory 540 may be coupled to internal bus 520, and may execute requests for bytecode applications in accordance with an embodiment of the present invention.

As shown in FIG. 5, microprocessor device 510 may also be coupled to a peripheral bus interface 550 and a peripheral bus 560. While many devices may be coupled to peripheral bus 560, shown in FIG. 5 is a wireless interface 570 which is in turn coupled to an antenna 580. In various embodiments antenna 580 may be a dipole antenna, helical antenna, global system for mobile communication (GSM) or another such antenna. While not shown in FIG. 5, it is to be understood that wireless device 500 may include a virtual machine, JIT buffer, and libraries in accordance with an embodiment of the present invention (e.g., as shown in FIG. 1).

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
providing a compiled version of at least a portion of a bytecode application to a wireless device from a data processing system.

2. The method of claim 1, wherein the data processing system includes a plurality of compiled applications derived from bytecode applications.

3. The method of claim 1, further comprising using device information of the wireless device to determine an amount of the compiled version to provide to the wireless device.

4. The method of claim 1, further comprising performing just-in-time compiling on at least a portion of the bytecode application on the wireless device.

5. The method of claim 1, wherein the data processing system comprises a server of a service provider of a wireless network.

6. The method of claim 5, further comprising sending the bytecode application from the wireless device to a second data processing system external to the wireless network for compilation.

7. The method of claim 6, wherein the wireless device is coupled to the second data processing system via a wireless local area network connection.

8. A method comprising:
communicating with a first data processing system if bytecodes exist in an application requested by a wireless device; and
providing a compiled native code segment corresponding to at least a portion of the application to the wireless device from a remote source.

9. The method of claim 8, wherein the remote source comprises the first data processing system.

10. The method of claim 8, wherein communicating with the first data processing system comprises requesting the compiled native code segment using a support node of a wireless network.

11. The method of claim 8, further comprising preprocessing a data stream containing the application to determine whether the bytecodes exist in the application.

12. The method of claim 8, wherein providing the compiled native code segment comprises transmitting the compiled native code segment using general packet radio services.

13. An article comprising a machine-readable storage medium containing instructions that if executed enable a system to:
provide a compiled version of at least a portion of a bytecode application to a wireless device from the system.

14. The article of claim 13, further comprising instructions that if executed enable the system to cache a plurality of compiled applications derived from bytecode applications.

15. The article of claim 13, further comprising instructions that if executed enable the system to use device information of the wireless device to determine an amount of the compiled version to provide to the wireless device.

16. The article of claim 13, further comprising instructions that if executed enable the system to just-in-time compile at least the portion of the bytecode application.

17. The article of claim 13, further comprising instructions that if executed enable the system to send the bytecode application to a second data processing system for compilation.

18. An apparatus comprising:
at least one storage device to store code to provide a compiled version of at least a portion of a bytecode application to a wireless device from a data processing system.

19. The apparatus of claim 18, wherein the data processing system comprises a server of a service provider of a wireless network.

20. The apparatus of claim 19, further comprising a second server coupled to the server, the second server to compile the bytecode application into the compiled version.

21. The apparatus of claim 19, wherein the server includes an interface to couple the server to a support node of the wireless network.

22. The apparatus of claim 19, wherein server includes a just-in-time compiler.

23. The apparatus of claim 19, wherein the server includes a plurality of compiled applications derived from bytecode applications.

24. A system comprising:
at least one storage device to store code to communicate with a data processing system to request a compiled version of an application requested by the system if bytecodes exist in the application, the system comprising a wireless device; and
a global system for mobile communication transceiver coupled to the at least one storage device.

25. The system of claim 24, further comprising a wireless local area network interface coupled to the at least one storage device to communicate with the data processing system.

26. The system of claim 25, wherein the data processing system is coupled to the wireless device via a wireless local area network.

27. The system of claim 24, wherein the wireless device includes a just-in-time compiler.

28. A method comprising:
requesting an application including bytecodes via a wireless device; and
receiving a compiled version of the application at the wireless device from a remote source.

29. The method of claim 28, further comprising forwarding the application from the wireless device to the remote source.

30. The method of claim 28, further comprising executing the compiled version on the wireless device.

31. The method of claim 28, wherein receiving the compiled version comprises receiving the compiled version from a server of a service provider.
